(19) United States
(12) Patent Application Publication
(10) Pub. No.: US 2017/0064620 A1
(43) Pub. Date: Mar. 2, 2017

(54) UNIFIED DISCOVERY SIGNAL FOR SMALL CELL AND DEVICE-TO-DEVICE DISCOVERY

(71) Applicant: NOKIA TECHNOLOGIES OY, Espoo (FI)

(72) Inventor: Haiming WANG, Beijing (CN)

(21) Appl. No.: 15/122,807

(22) PCT Filed: Mar. 28, 2014
(86) PCT No.: PCT/CN2014/074321

§ 371 Date: Aug. 31, 2016

(51) Int. Cl. H04W 48/16; H04W 8/00

(52) U.S. Cl. CPC H04W 48/16; H04W 8/005

(57) ABSTRACT

In accordance with an example embodiment of the present invention, an apparatus comprising: at least one processor; and at least one memory including computer program code, wherein the at least one memory and the computer program code are configured to, with the at least one processor, cause the apparatus to perform at least the following: detect a discovery signal; and determine small cell discovery or device-to-device discovery based on the detected discovery signal.

### TECHNICAL FIELD

The present application relates to wireless communications and, in particular, unified discovery signal design for small cell and device-to-device discovery.

### BACKGROUND

The expected increase in wireless data transmissions may mean that there will be a need to deploy more network capacity. One efficient way to increase the network capacity is by deploying small cells for offloading purposes or offloading cells in general. These small cells can be deployed on the same or separate carriers relative to the serving cell, and the mixed environment with macro/large cells and small cells are often referred to heterogeneous networks (hetnets). Use of hetnets may provide opportunities for offloading traffic from the macro cells to, for example, a higher speed or a higher capacity small cell.

There are various types of networks, including infrastructure networks (e.g., the internet, cellular networks, and/or the like), ad-hoc networks, or a combination of both. In the case of the infrastructure network, the user equipment communicates (e.g., transmits and/or receives information) with another user equipment through an access point, such as base station or a wireless access point. In the case of the ad-hoc network, the user equipment communicates directly with another user equipment. Ad hoc networks are also called “proximity services” (ProSe) and/or “device-to-device” (D2D) networks, referring to the wireless direct link(s) between a plurality of user equipment. In the case of ad-hoc, D2D communications, some of the D2D communications may also be controlled by a base station, providing so-called “cellular controlled” D2D communications (which is also referred to as cellular assisted D2D communications). In cellular controlled D2D communications, two devices may be directly linked via a D2D connection, and one or both of the devices may be attached to a base station, such as an enhanced Node B (eNB) base station, to exchange control information with the eNB (or other nodes of the network).

### SUMMARY

Various aspects of examples of the invention are set out in the claims.

According to a first aspect of the present invention, an apparatus comprising: at least one processor; and at least one memory including computer program code, wherein the at least one memory and the computer program code are configured to, with the at least one processor, cause the apparatus to perform at least the following: detect a discovery signal; and determine small cell discovery or device-to-device discovery based on the detected discovery signal.

According to a second aspect of the present invention, a method comprising: detecting a discovery signal; and determining small cell discovery or device-to-device discovery based on the detected discovery signal.

According to a third aspect of the present invention, a computer program product comprising a non-transitory computer-readable medium bearing computer program code embodied therein for use with a computer, the computer program code comprising: code for detecting a discovery signal; and code for determining small cell discovery or device-to-device discovery based on the detected discovery signal.

According to a fourth aspect of the present invention, an apparatus comprising: means for detecting a discovery signal; and means for determining small cell discovery or device-to-device discovery based on the detected discovery signal.

### BRIEF DESCRIPTION OF THE DRAWINGS

For a more complete understanding of example embodiments of the present invention, reference is now made to the following descriptions taken in connection with the accompanying drawings in which:

FIG. 1 depicts an example of a small cell and D2D communication in which some embodiments of the present invention may be practiced;

FIG. 2 depicts an example process for small cell and D2D discovery in accordance with some embodiments of the invention;

FIG. 3(a)-(c) illustrate some examples for small cell and D2D discovery in accordance with some embodiments of the invention; and

FIG. 4 illustrates a block diagram of a user equipment in accordance with some embodiments of the invention.

### DETAILED DESCRIPTION OF THE DRAWINGS

Both small cell discovery and D2D discovery requires a specific discovery signal. The discovery is achieved by a terminal, for example, a small cell base station or a D2D device, sending a discovery signal with good synchronization and detection property, then other user equipment (UE) could detect the terminal by listening to the discovery signal. A unified discovery signal, which meets the requirement from both tasks, will lead to less standardization effort and simplify the algorithm implementation as there is no need to design algorithms separately for small cell discovery and D2D discovery.

However, a unified discovery signal means a UE may not be able to distinguish the source. For example, when a UE detects a discovery signal, it may not know whether the signal is transmitted by a small cell base station or another D2D device. The problem may be solved by using different frequencies for small cell deployment and D2D service. For example, in a Long Term Evolution (LTE) frequency division duplex (FDD) system, the small cell discovery signal is sent in downlink frequency while D2D is sent in uplink frequency. Alternatively, if UE could get assistance from the network, for example, an overlaid macro cell, it could separate the discovery signal from the dedicated time and frequency resource. However, when the same frequency is used for both small cell and D2D discovery, it leads to UE behavior confusion. For example, a UE turns on the receiver searching for small cells for service, but instead it detects a discovery signal transmitted by another D2D device. This UE tries to access the small but fails because no such small cell exists.

The subject matter disclosed herein provides a way for facilitating small cell and D2D discovery. Specifically, there is provided a way of having a unified discovery signal for small cell discovery and D2D discovery. Based on the unified discovery signal, a UE may determine whether a small cell is discovered or a D2D device is discovered.

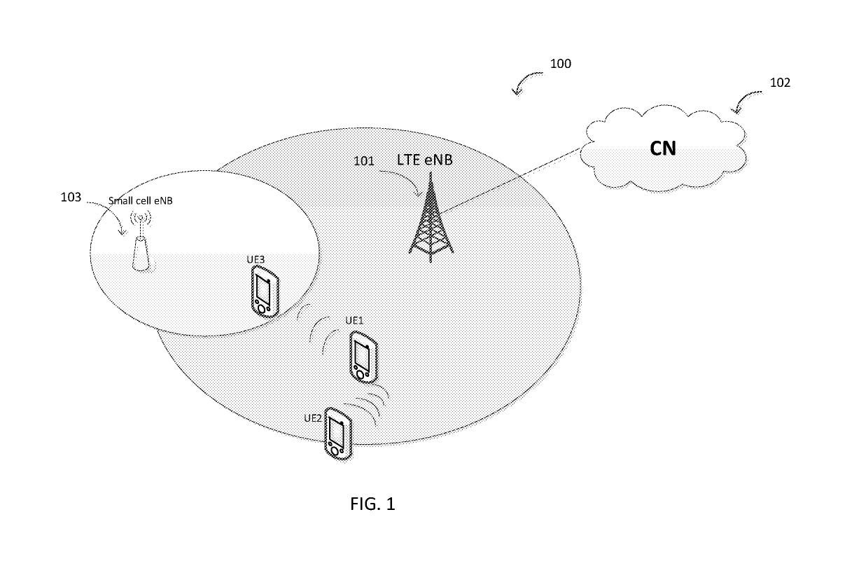

FIG. 1 depicts an example of a small cell and D2D communication in which some embodiments of the present invention may be practiced. As illustrated in FIG. 1, UE1, UE2 and UE3 are served by a macro cell base station, LTE eNB 101. UE1 is communicating with UE2 through D2D service. UE3 is under the coverage of a small cell base station 103. The discovery signal UE3 detected may come from the small cell base station 103, or from a D2D device, such as UE1 or UE2.

Although FIG. 1 depicts a certain quantity of UE, base stations, and cells, other quantities and configurations may be used as well. It is noted that the term of base station is and will be hereinafter described for purposes of example. For example, the base station may be an access point, and/or the likes.

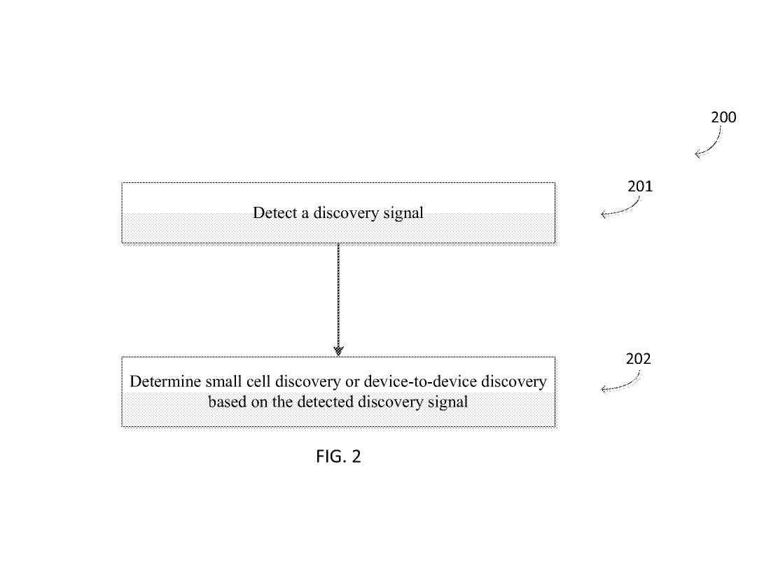

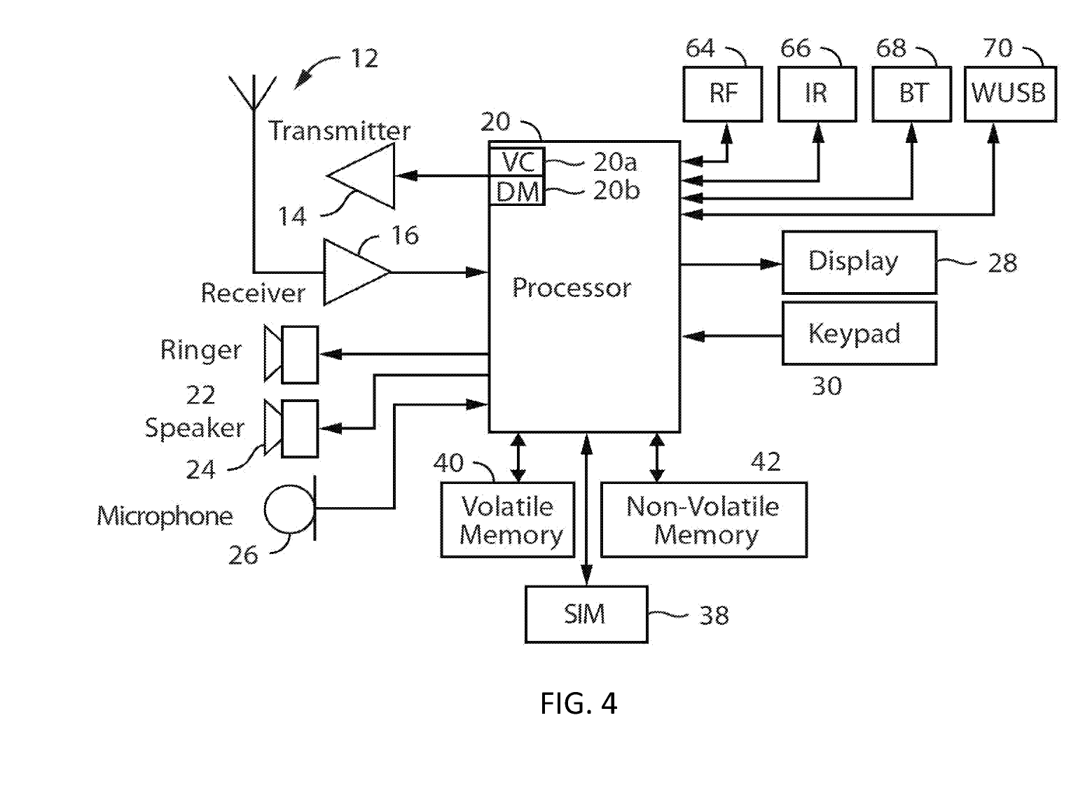

FIG. 2 is a flow chart illustrating an example method for small cell and D2D discovery in accordance with an example embodiment of the invention. Example method 200 may be performed by or in an apparatus, such as UE3 of FIG. 1, and the apparatus 10 of FIG. 4.

At 201, the apparatus detects a discovery signal.

In some example embodiments, the discovery signal comprises a preamble, wherein the preamble comprises a primary synchronization sequence (PSS) and a secondary synchronization sequence (SSS). For example, reference can be made to 3GPP TS 36.211 V11.5.0 (2013-12) 3rd Generation Partnership Project; Technical Specification Group Radio Access Network; Physical channels and modulation (Release 11). The PSS and SSS may use the sequences as defined in the reference. For example, the sequence d(n) used for the primary synchronization signal is generated from a frequency-domain Zadoff-Chu sequence according to

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix}$$

where u is the Zadoff-Chu root sequence index.

The sequence used for the second synchronization signal is an interleaved concatenation of two length-31 binary sequences. The concatenated sequence is scrambled with a scrambling sequence given by the primary synchronization signal.

In some other example embodiments, the discovery signal comprises a preamble, wherein the preamble comprises a sequence, for example, a Zadoff-Chu sequence.

At 202, the apparatus determines small cell discovery or device-to-device discovery based on the detected discovery signal.

In some example embodiments, the discovery signal comprises a preamble, wherein the preamble comprises a PSS and a SSS.

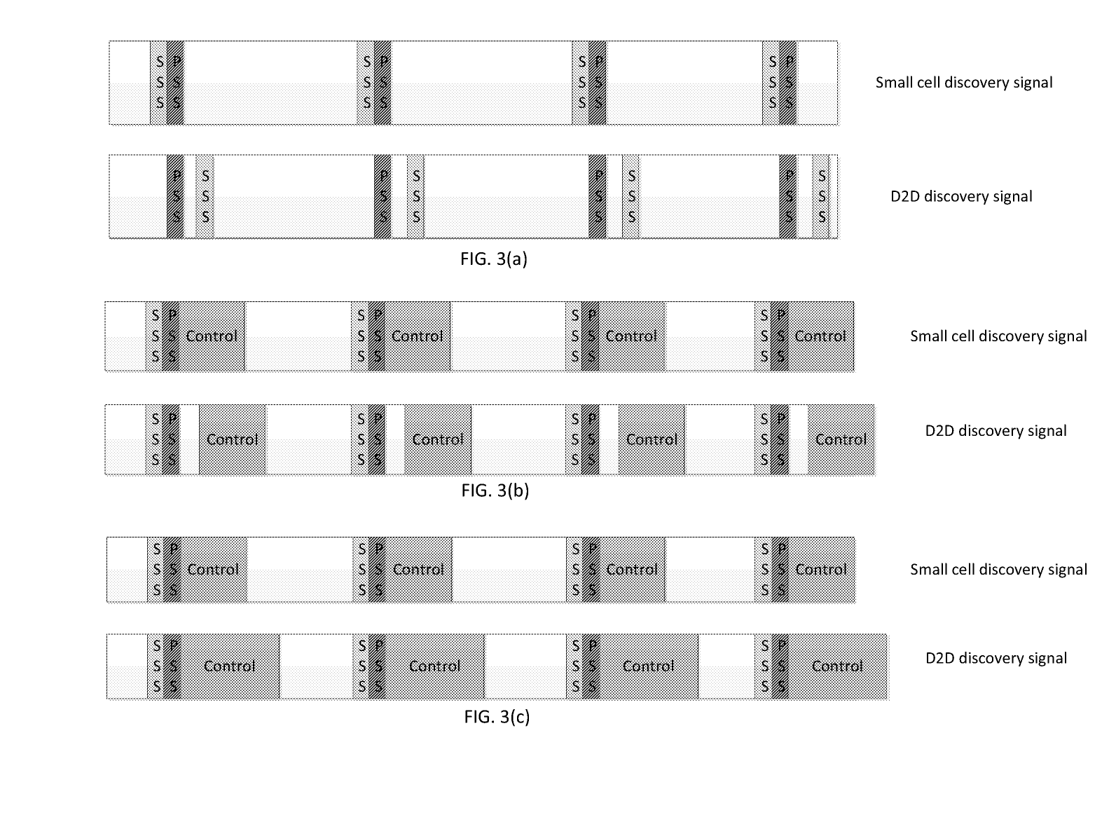

The apparatus may determine small cell discovery or D2D discovery based on relative position of the PSS and the SSS. FIG. 3(a) illustrates an example for small cell and D2D discovery in accordance with some embodiments of the invention. As shown in FIG. 3(a), the relative PSS/SSS position is used to indicate the source, that is, the discovery signal is sent from a small cell or a D2D device. For example, the small cell discovery signal applies a legacy FDD PSS/SSS position such as defined in the above reference, while D2D uses another pattern, for example, SSS is sent after PSS with possible one symbol gap. When a UE is searching for a small cell, it will detect PSS first. If the results exceed a certain threshold, it will search the SSS at the symbol before PSS. Therefore when the UE is within coverage area of a small cell, the UE can discover the small cell. On the other hand, the PSS from a D2D device may trigger the PSS detection, but the UE will not find the SSS because the SSS for D2D discovery is one symbol after the PSS.

The apparatus may determine small cell discovery or D2D discovery based on root index of the PSS and/or root index of the SSS. For example, root index n is used for small cell discovery while root index m is used for D2D discovery. The apparatus may determine small cell discovery or D2D discovery based on repetition pattern. For example, repetition pattern A is used for small cell discovery while repetition pattern B is used for D2D discovery. The apparatus may determine small cell discovery or D2D discovery based on scrambling code for the preamble. For example, different scrambling codes are applied to the preamble—one scrambling code is used for small cell discovery and another for D2D discovery. The apparatus may also determine small cell discovery or D2D discovery based on frequency hopping pattern. For example, hopping pattern A is used small cell discovery and hopping pattern B is used for D2D discovery.

The discovery signal may further comprise a control signal. The apparatus may determine small cell discovery or D2D discovery based on the relative position of the preamble and the control signal. After preamble detection, UE tries to decode the control part information based on two hypothesis of timing or frequency position. FIG. 3(b) illustrates an example for small cell and D2D discovery in accordance with some embodiments of the invention. As shown in FIG. 3(b), the source indication is achieved by different control signal position. The PSS/SSS pattern is the same for both cases, but the control part is in different timing position. Therefore the UE can determine the discovery signal is sent from a small cell or a D2D device. In such case, UE will not detect the uninterested control signal. Such principle may also apply in the frequency domain. For example, the control part is in different frequency position for small cell and D2D discovery signal.

The apparatus may determine small cell discovery or D2D discovery based on control signal payload size. After preamble detection, UE blindly detects the control part based on two hypothesis of payload size. FIG. 3(c) illustrates an example for small cell and D2D discovery in accordance with some embodiments of the invention. As shown in FIG. 3(c), the source indication is achieved by different control signal payload size. Here it is assumed the control signal has CRC check. A UE will fail on the CRC check if the control signal is not the interested one. If the payload size is the same, the apparatus may determine small cell discovery or D2D discovery based on scrambling code of cyclic redundancy check (CRC). Different CRC scrambling codes are applied for small cell and D2D discovery signal. After preamble detection, UE performs CRC with two hypothesis of scrambling codes. UE fails on the CRC check on the uninterested control signal decoding. Therefore false alarm will not be triggered.

In some other example embodiments, the discovery signal comprises a preamble, wherein the preamble comprises a sequence, for example, a Zadoff-Chu sequence.

The apparatus may determine small cell discovery or D2D discovery based on root index of the sequence. For example, root index n is used for small cell discovery while root index m is used for D2D discovery. The apparatus may determine small cell discovery or D2D discovery based on sequence length. For example, different sequence length is used for small cell and D2D discovery signal. The apparatus may determine small cell discovery or D2D discovery based on cyclic shift of the sequence. For example, different cyclic shift is used for small cell and D2D discovery signal. The apparatus may determine small cell discovery or D2D discovery based on repetition pattern. For example, repetition pattern A is used for small cell discovery signal while repetition pattern B is used for D2D discovery signal. The apparatus may determine small cell discovery or D2D discovery based on scrambling code for the sequence. For example, different scrambling code is used for small cell and D2D discovery signal.

The discovery signal may further comprise a control signal. The apparatus may determine small cell discovery or D2D discovery based on relative position of the Zadoff-Chu sequence and the control signal. The apparatus may determine small cell discovery or D2D discovery based on control signal payload size, and/or scrambling code of CRC which are described in previous sections.

It is noted that the example embodiments described herein may be combined to enhance the performance. For example, different preamble sequence, e.g. different PSS/SSS positions, is used for the two sources while different payload size and/or different CRC scrambling is also used. Such combined embodiments will further reduce the likelihood of false alarm.

FIG. 4 illustrates a block diagram of an apparatus 10, which can be configured as user equipment in accordance with some example embodiments.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. Accordingly, although illustrated in FIG. 4 as a single processor, in some embodiments the processor 20 comprises a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the apparatus 10 may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be developed in the future.

Some Narrow-band Advanced Mobile Phone System, NAMPS, as well as Total Access Communication System, TACS, mobile terminal apparatuses may also benefit from embodiments of this invention, as should dual or higher mode phone apparatuses, for example, digital/analog or TDMA/CDMA/analog phones. Additionally, apparatus 10 may be capable of operating according to Wi-Fi or Worldwide Interoperability for Microwave Access, WiMAX, protocols.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor may additionally comprise an internal voice coder, VC, 20a, an internal data modem, DM, 20b, and/or the like. Further, the processor may comprise functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like

Apparatus 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus 10 may comprise a battery for powering various circuits related to the apparatus, for example, a circuit to provide mechanical vibration as a detectable output. The user input interface may comprise devices allowing the apparatus to receive data, such as a keypad 30, a touch display, which is not shown, a joystick, which is not shown, and/or at least one other input device. In embodiments including a keypad, the keypad may comprise numeric 0-9 and related keys, and/or other keys for operating the apparatus.

As shown in FIG. 4, apparatus 10 may also include one or more means for sharing and/or obtaining data. For example, the apparatus may comprise a short-range radio frequency, RF, transceiver and/or interrogator 64 so data may be shared with and/or obtained from electronic devices in accordance with RF techniques. The apparatus may comprise other short-range transceivers, such as, for example, an infrared, IR, transceiver 66, a Bluetooth™, BT, transceiver 68 operating using Bluetooth™ brand wireless technology developed by the Bluetooth™ Special Interest Group, a wireless universal serial bus, USB, transceiver 70 and/or the like. The Bluetooth™ transceiver 68 may be capable of operating according to low power or ultra-low power Bluetooth™ technology, for example, Wibree™, radio standards. In this regard, the apparatus 10 and, in particular, the short-range transceiver may be capable of transmitting data to and/or receiving data from electronic devices within a proximity of the apparatus, such as within 10 meters, for example. Although not shown, the apparatus may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise a non-transitory memory, such as a subscriber identity module, SIM, 38, a removable user identity module, R-UIM, and/or the like, which may store information elements related to a mobile subscriber. In addition to the SIM, the apparatus may comprise other removable and/or fixed memory. The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment. The memories may comprise an identifier, such as for example, an international mobile equipment identification (IMEI) code, capable of uniquely identifying apparatus 10.

FIG. 7 depicts an example implementation of a base station in accordance with some embodiments of the invention, such as eNB of FIG. 1. The base station 70 may include one or more antennas 740 configured to transmit via a downlink and configured to receive uplinks via the antenna(s). The base station may further include a plurality of radio interfaces 730 coupled to the antenna 740. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 730 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). The base station may further include one or more network interfaces 750, for receiving and transmitting to other base stations and/or core networks. The base station may further include one or more processors, such as processor 720, for controlling the interfaces 730 and 750 and for accessing and executing program code stored in memory 710. In some example embodiments, the memory 710 includes code, which when executed by at least one processor causes one or more of the operations described herein with respect to a base station.

Without in any way limiting the scope, interpretation, or application of the claims appearing below, a technical effect of one or more of the example embodiments disclosed herein may include enabling discovery signal detection for small cells and device to device discovery.

Embodiments of the present invention may be implemented in software, hardware, application logic or a combination of software, hardware and application logic. The software, application logic and/or hardware may reside on a non-transitory memory 40 and/or 42, the control apparatus 20 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 4. A computer-readable medium may comprise a computer-readable non-transitory storage medium that may be any media or means that can contain or store the instructions for use by or in connection with an instruction execution system, apparatus, or device, such as a computer. The scope of the present invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Other embodiments may be within the scope of the following claims. The term “based on” includes “based at least in part on”.

1-20. (canceled)

21. A method, comprising:
detecting, by a user equipment, a discovery signal; and
determining small cell discovery or device-to-device discovery based on the detected discovery signal.

22. The method according to claim 21, wherein said discovery signal comprises a preamble, wherein the preamble comprises a primary synchronization sequence and a secondary synchronization sequence.

23. The method according to claim 22, wherein said determining small cell discovery or device-to-device discovery based on the detected discovery signal comprises determining small cell discovery or device-to-device discovery based on at least one of: relative position of the primary synchronization sequence and the secondary synchronization sequence, root index of the primary synchronization sequence, root index of the secondary synchronization sequence, repetition pattern, scrambling code for the preamble, and hopping pattern for the preamble.

24. The method according to claim 22, wherein said discovery signal further comprises a control signal, and wherein said determining small cell discovery or device-to-device discovery based on the detected discovery signal comprises determining small cell discovery or device-to-device discovery based on at least one of: relative position of the preamble and the control signal, control signal payload size, and scrambling code of cyclic redundancy check.

25. The method according to claim 21, wherein said discovery signal comprises a Zadoff-Chu sequence.

26. The method according to claim 25, wherein said determining small cell discovery or device-to-device discovery based on the detected discovery signal comprises determining small cell discovery or device-to-device discovery based on at least one of: root index of the sequence, sequence length, cyclic shift of the sequence, repetition pattern, and scrambling code for the sequence.

27. The method according to claim 25, wherein said discovery signal further comprises a control signal, and wherein said determining small cell discovery or device-to-device discovery based on the detected discovery signal comprises determining small cell discovery or device-to-device discovery based on at least one of: relative position of the Zadoff-Chu sequence and the control signal, control signal payload size, and scrambling code of cyclic redundancy check.

28. An apparatus, comprising:
at least one processor; and
at least one memory including computer program code,
wherein the at least one memory and the computer program code are configured to, with the at least one processor, cause the apparatus to:
detect a discovery signal; and
determine small cell discovery or device-to-device discovery based on the detected discovery signal.

29. The apparatus according to claim 28, wherein said discovery signal comprises a preamble, wherein the preamble comprises a primary synchronization sequence and a secondary synchronization sequence.

30. The apparatus according to claim 29, wherein said determining small cell discovery or device-to-device discovery based on the detected discovery signal comprises determining small cell discovery or device-to-device discovery based on at least one of: relative position of the primary synchronization sequence and the secondary synchronization sequence, root index of the primary synchronization sequence, root index of the secondary synchronization sequence, repetition pattern, scrambling code for the preamble, and hopping pattern for the preamble.

31. The apparatus according to claim 29, wherein said discovery signal further comprises a control signal, and wherein said determining small cell discovery or device-to-device discovery based on the detected discovery signal comprises determining small cell discovery or device-to-device discovery based on at least one of: relative position of the preamble and the control signal, control signal payload size, and scrambling code of cyclic redundancy check.

32. The apparatus according to claim 28, wherein said discovery signal comprises a Zadoff-Chu sequence.

33. The apparatus according to claim 32, wherein said determining small cell discovery or device-to-device discovery based on the detected discovery signal comprises determining small cell discovery or device-to-device discovery based on at least one of: root index of the sequence, sequence length, cyclic shift of the sequence, repetition pattern, and scrambling code for the sequence.

34. The apparatus according to claim 32, wherein said discovery signal further comprises a control signal, and wherein said determining small cell discovery or device-to-device discovery based on the detected discovery signal comprises determining small cell discovery or device-to-device discovery based on at least one of: relative position of the Zadoff-Chu sequence and the control signal, control signal payload size, and scrambling code of cyclic redundancy check.

35. A computer program product comprising a non-transitory computer-readable medium bearing computer program code embodied therein for use with a computer, the computer program code comprising:
code for detecting a discovery signal; and
code for determining small cell discovery or device-to-device discovery based on the detected discovery signal.

36. The computer program product according to claim 35, wherein said discovery signal comprises a preamble, wherein the preamble comprises a primary synchronization sequence and a secondary synchronization sequence.

37. The computer program product according to claim 36, wherein said determining small cell discovery or device-to-device discovery based on the detected discovery signal comprises determining small cell discovery or device-to-device discovery based on at least one of: relative position of the primary synchronization sequence and the secondary synchronization sequence, root index of the primary synchronization sequence, root index of the secondary synchronization sequence, repetition pattern, scrambling code for the preamble, and hopping pattern for the preamble.

38. The computer program product according to claim 36, wherein said discovery signal further comprises a control signal, and wherein said determining small cell discovery or device-to-device discovery based on the detected discovery signal comprises determining small cell discovery or device-to-device discovery based on at least one of: relative position of the preamble and the control signal, control signal payload size, and scrambling code of cyclic redundancy check.

39. The computer program product according to claim 35, wherein said discovery signal comprises a Zadoff-Chu sequence.

40. The computer program product according to claim 39, wherein said determining small cell discovery or device-to-device discovery based on the detected discovery signal comprises determining small cell discovery or device-to-device discovery based on at least one of: root index of the sequence, sequence length, cyclic shift of the sequence, repetition pattern, and scrambling code for the sequence.
